(19) United States
(12) Patent Application Publication
(10) Pub. No.: US 2024/0278286 A1
(43) Pub. Date: Aug. 22, 2024

(54) ULTRASONIC DEVICE

(71) Applicant: SEIKO EPSON CORPORATION, Tokyo (JP)

(72) Inventors: Chikara KOJIMA, Matsumoto-shi (JP); Keita KUBO, Matsumoto-shi (JP); Katsuhiro IMAI, MINOWA-MACHI (JP); Hironori SUZUKI, CHINO-SHI (JP)

(21) Appl. No.: 18/439,778

(22) Filed: Feb. 13, 2024

(30) Foreign Application Priority Data
Feb. 16, 2023 (JP) 2023-022191

(51) Int. Cl. B06B 1/06; G10K 11/02

(52) U.S. Cl. CPC B06B 1/067; G10K 11/02

(57) ABSTRACT

An ultrasonic device includes a vibration plate having a first surface and a second surface opposite to the first surface, an acoustic matching layer that is provided on the first surface and is brought into contact with an object, a piezoelectric element provided on the second surface, and a prevention portion that is disposed in a manner of surrounding the piezoelectric element, and prevents vibration of the vibration plate. When a thickness of the acoustic matching layer is defined as t, a sound velocity of ultrasonic waves is defined as V, and a center frequency of ultrasonic waves transmitted from the first surface is defined as f, t≤V/f is satisfied.

The present application is based on, and claims priority from JP Application Serial Number 2023-022191, filed Feb. 16, 2023, the disclosure of which is hereby incorporated by reference herein in its entirety.

### BACKGROUND

### 1. Technical Field

The present disclosure relates to an ultrasonic device.

### 2. Related Art

JP-A-2015-188208 discloses an ultrasonic device including a substrate formed with an opening, a vibration plate that closes the opening, and a piezoelectric element stacked on an opposite side of the vibration plate from the opening, as an ultrasonic device that transmits ultrasonic waves to a living body.

In the ultrasonic device disclosed in JP-A-2015-188208, a prevention portion surrounding the piezoelectric element is provided on an opposite side of the vibration plate from the substrate, that is, a side where the piezoelectric element is stacked. The prevention portion defines a vibration region of the vibration plate by preventing vibration of the vibration plate. Accordingly, when a voltage is applied to the piezoelectric element, a portion of the vibration plate surrounded by the prevention portion vibrates, and ultrasonic waves having a frequency corresponding to an area of a region surrounded by the prevention portion are output.

JP-A-2015-188208 is an example of the related art.

However, when an ultrasonic device is brought into contact with an object such as a living body to transmit ultrasonic waves, air bubbles enter an inner side of the opening and transmission of ultrasonic waves is impaired.

In order to prevent the influence of air bubbles, it is conceivable to prevent the air bubbles from entering by filling the opening with an acoustic matching portion having an acoustic impedance close to that of an object. However, the acoustic matching portion has a wavelength dependence on transmittance of ultrasonic waves, and when a band of ultrasonic waves output from the ultrasonic device is widened, wavelength unevenness for each frequency may occur in transmittance of ultrasonic waves.

### SUMMARY

An ultrasonic device according to a first aspect of the disclosure includes a vibration plate having a first surface and a second surface opposite to the first surface; an acoustic matching layer that is provided on the first surface and is brought into contact with an object; a piezoelectric element provided on the second surface; and a prevention portion that is disposed on the second surface in a manner of surrounding the piezoelectric element, and prevents vibration of the vibration plate. When a thickness of the acoustic matching layer is defined as t, a sound velocity of ultrasonic waves is defined as V, and a center frequency of ultrasonic waves transmitted from the first surface is defined as f, t≤V/f is satisfied.

### BRIEF DESCRIPTION OF THE DRAWINGS

FIG. 1 is a cross-sectional view showing a schematic configuration of an ultrasonic device according to an embodiment of the disclosure.

FIG. 2 is a plan view showing the ultrasonic device according to the embodiment as viewed from an ultrasonic waves emission surface side.

FIG. 3 is a diagram showing a change in sound pressure relative to a frequency when the frequency of ultrasonic waves changes in a range of 1 MHz to 10 MHz with 7 MHz serving as a center frequency in the ultrasonic device according to the embodiment.

FIG. 4 is a diagram showing a change in sound pressure relative to a frequency when the frequency of ultrasonic waves changes in a range of 11 MHz to 20 MHz with 15 MHz serving as a center frequency in the ultrasonic device according to the embodiment.

FIG. 5 is a diagram showing a change in sound pressure relative to a frequency when the frequency of ultrasonic waves changes in a range of 0.1 MHz to 1.0 MHz with 0.5 MHz serving as a center frequency in the ultrasonic device according to the embodiment.

FIG. 6 is a diagram comparing a schematic configuration of an ultrasonic device in the related art serving as a comparative example with a schematic configuration of the ultrasonic device according to the embodiment.

FIG. 7 is a diagram showing a relationship between a normalized radiation impedance and a distance between prevention portions.

### DESCRIPTION OF EMBODIMENTS

Hereinafter, an ultrasonic device according to an embodiment of the disclosure will be described.

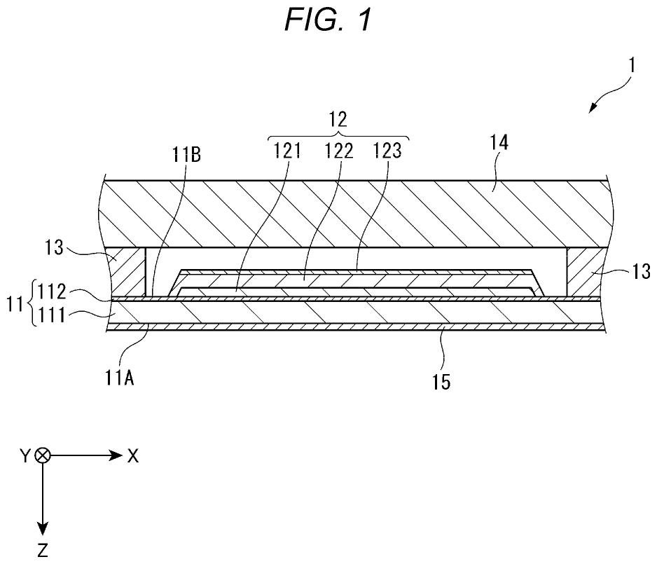

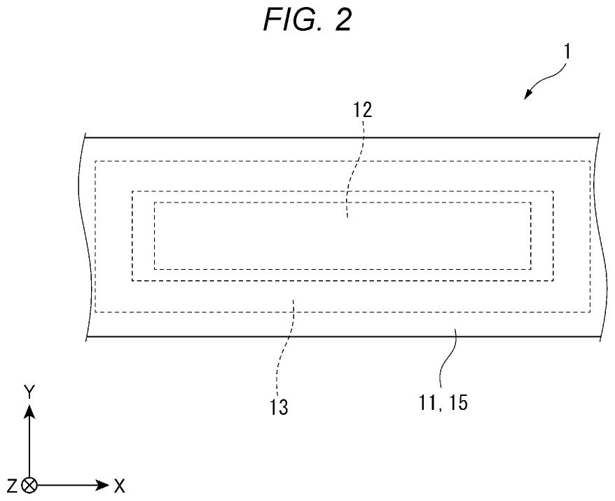

FIG. 1 is a cross-sectional view showing a schematic configuration of an ultrasonic device 1 according to the embodiment, and FIG. 2 is a plan view showing the ultrasonic device 1 according to the embodiment as viewed from an ultrasonic waves emission surface side.

The ultrasonic device 1 is a device that transmits ultrasonic waves to at least an object, and may have a function of receiving ultrasonic waves reflected inside the object. Examples of the object include a living body such as a human body, a concrete structure, and fluid flowing through a pipe. For example, an ultrasonic device that performs ultrasonic treatment on an organ by outputting ultrasonic waves to the organ having a predetermined depth in a living body can be exemplified as the ultrasonic device 1 that outputs ultrasonic waves to a living body. The ultrasonic device 1 can be used as a device that obtains an internal tomographic image in a living body by transmitting ultrasonic waves into the living body and receiving ultrasonic waves reflected in the living body. The ultrasonic device 1 that outputs ultrasonic waves to a structure can be used as a device that examines an internal structure of the structure in a non-destructive manner. The ultrasonic device 1 that outputs ultrasonic waves to a pipe can be used as a device that forms standing waves by ultrasonic waves in the pipe and captures fine particles contained in fluid in the pipe.

In the embodiment, the ultrasonic device 1 that outputs ultrasonic waves to a living body will be described as an example.

As shown in FIG. 1, the ultrasonic device 1 according to the embodiment includes a vibration plate 11, a piezoelectric element 12, prevention portions 13, a sealing plate 14, and an acoustic matching layer 15.

The vibration plate 11 includes a first substrate 111 and a second substrate 112. The first substrate 111 is a flat plate-shaped substrate made of a semiconductor substrate such as Si. The second substrate 112 is a substrate stacked on the first substrate 111, and is a flat plate-shaped substrate made of a metal oxide such as SiO₂ or ZrO₂.

An opposite surface of the first substrate 111 from the second substrate 112 constitutes a first surface 11A according to the disclosure. An opposite surface of the second substrate 112 from the first substrate 111 constitutes a second surface 11B according to the disclosure, and the first surface 11A and the second surface 11B are in a front and back relationship.

In the following description, a direction from the first surface 11A toward the second surface 11B, that is, a normal direction of the first surface 11A and the second surface 11B is defined as a Z direction. A direction orthogonal to the Z-direction is defined as an X direction, and a direction orthogonal to the X direction and the Z direction is defined as a Y direction.

As described above, the first substrate 111 and the second substrate 112 are flat plate-shaped members, and the first surface 11A and the second surface 11B are flat surfaces and are parallel to an XY plane. More specifically, the first surface 11A is preferably formed to have at least a surface roughness (arithmetic average roughness) of 10 μm or less. Accordingly, turbulent reflection of ultrasonic waves on the first surface 11A can be prevented, and a loss of ultrasonic waves at an interface between the ultrasonic device and the acoustic matching layer 15 can be well prevented.

Here, the first substrate 111 is formed to be thicker than the second substrate 112. For example, when it is necessary to form a piezoelectric layer 122 of the piezoelectric element 12, which will be described later, and the piezoelectric layer 122 is made of PZT, the piezoelectric layer 122 can be appropriately formed by forming a ZrO₂ layer or a SiO₂ layer as the second substrate 112.

The piezoelectric layer 122 can be suitably formed by providing the second substrate 112 made of a metal oxide in the embodiment, and thereafter, the second substrate 112 may be removed. In this case, the vibration plate 11 includes the first substrate 111 only, one surface of the first substrate 111 is the first surface 11A, and the other surface is the second surface 11B. The second substrate 112 other than a portion where the piezoelectric element 12 is formed may be removed.

The piezoelectric element 12 is provided on the second substrate 112 of the vibration plate 11, that is, on the second surface 11B, and is implemented by stacking a first electrode 121, the piezoelectric layer 122, and a second electrode 123 in the −Z direction as shown in FIG. 1. The piezoelectric layer 122 in the embodiment is made of a perovskite transition metal oxide containing Pb, and for example, the piezoelectric layer 122 is PZT containing Pb, Zr, and Ti in the embodiment.

Here, a portion where the first electrode 121, the piezoelectric layer 122, and the second electrode 123 overlap one another in the Z direction is an active portion that expands and contracts when a voltage is applied between the first electrode 121 and the second electrode 123. When the piezoelectric element 12 expands and contracts, the vibration plate 11 provided with the piezoelectric element 12 vibrates to output ultrasonic waves. When ultrasonic waves are input to the vibration plate 11, the vibration plate 11 vibrates and the piezoelectric layer 122 of the piezoelectric element 12 is distorted, thereby generating a potential difference between upper and lower (±Z sides) electrodes. Accordingly, reception of ultrasonic waves can be detected by detecting the potential difference generated between the first electrode 121 and the second electrode 123.

Although FIG. 1 shows an example in which one piezoelectric element 12 is provided for simplification of the drawing, a plurality of piezoelectric elements 12 may be arranged in an array along the X direction and the Y direction or along either the X direction or the Y direction.

The prevention portion 13 is a member provided on the second surface 11B of the vibration plate 11, and is formed of, for example, a permanent resist. Specifically, the prevention portion 13 is formed in a frame shape surrounding an outer periphery of the piezoelectric element 12 as viewed from the Z direction. The prevention portion 13 prevents vibration of the vibration plate 11 to define a vibration region of the vibration plate 11 that is caused to vibrate by the piezoelectric element 12. That is, ultrasonic waves are output by vibrating a portion of the vibration plate 11 surrounded by the prevention portions 13 in the embodiment.

The sealing plate 14 has a thickness in the Z direction sufficiently larger than that of the vibration plate 11, and is joined to the vibration plate 11 via the prevention portion 13, thereby reinforcing the vibration plate 11 and preventing the prevention portion 13 from vibrating together with the vibration plate 11.

The acoustic matching layer 15 is provided on the first surface 11A of the vibration plate 11. In the embodiment, the first surface 11A of the vibration plate 11 is a continuous flat surface, and the acoustic matching layer 15 having a uniform thickness is formed on the first surface 11A. Therefore, for example, different from a configuration in the related art in which the acoustic matching layer is filled in an opening provided in a substrate, generation of air bubbles is prevented.

Here, the ultrasonic device 1 according to the embodiment can transmit, using vibration of the vibration plate 11, ultrasonic waves to an object with which the ultrasonic device 1 is brought into direct contact. However, when the acoustic matching layer 15 is not provided and the vibration plate 11 is brought into close contact with a living body, for example, there is a high possibility that a space (air bubbles) is generated between the vibration plate 11 having high rigidity and a surface of the elastic and soft living body. Therefore, it is more difficult to bring the first surface 11A of the vibration plate 11 which is harder than the living body and is flat into close contact with a surface of the living body, and air bubbles are likely to occur even when gel or the like is used. When the vibration plate 11 is pressed against an object, the vibration plate 11 may be damaged.

Therefore, the acoustic matching layer 15 is provided between the vibration plate 11 and a living body as a buffer member that can prevent generation of air bubbles, can prevent damage to the vibration plate 11, and is softer than the vibration plate 11. It is possible to prevent reflection of ultrasonic waves at an interface between the vibration plate 11 and the living body, and appropriately transmit ultrasonic waves to the living body, by providing the acoustic matching layer 15 having an acoustic impedance close to that of the living body as the buffer member.

### Thickness of Acoustic Matching Layer 15

Next, a thickness of the acoustic matching layer 15 will be described.

A living body is exemplified as an object in the embodiment, and in this case, it is preferable to set a center frequency of ultrasonic waves within a range of 0.5 MHz to 15 MHZ based on a depth of an organ in a diagnosis region. In the ultrasonic device 1, it is more preferable that a frequency corresponding to only a specific depth is not set, and a frequency of ultrasonic waves to be output can be changed in a predetermined frequency range around the center frequency.

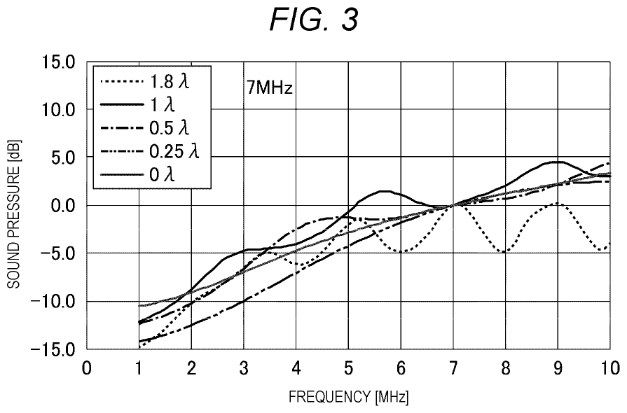

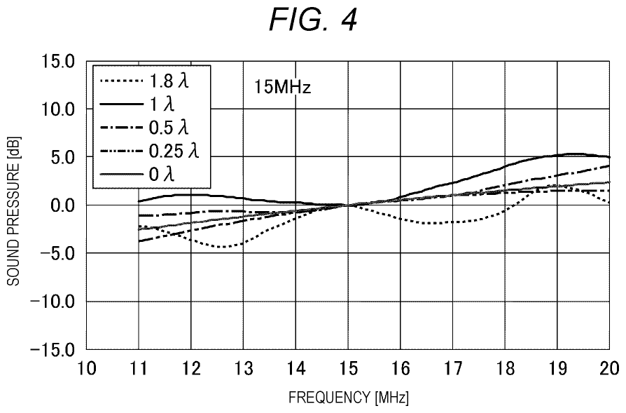

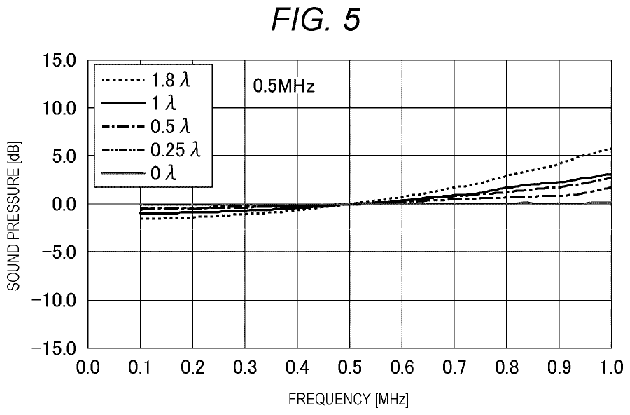

FIG. 3 is a diagram showing a change in sound pressure relative to a frequency when the frequency of ultrasonic waves changes in a range of 1 MHz to 10 MHz with 7 MHz serving as a center frequency. FIG. 4 is a diagram showing a change in sound pressure relative to a frequency when the frequency of ultrasonic waves changes in a range of 11 MHz to 20 MHz with 15 MHz serving as a center frequency. FIG. 5 is a diagram showing a change in sound pressure relative to a frequency when the frequency of ultrasonic waves changes in a range of 0.1 MHz to 1.0 MHz with 0.5 MHz serving as a center frequency. In FIGS. 3 to 5, a gray solid line indicates sound pressure when the acoustic matching layer 15 is not provided (0λ). When a thickness of the acoustic matching layer 15 is defined as t and a wavelength of ultrasonic waves is defined as λ, a solid line indicates sound pressure in the case of t=1.0λ, a broken line indicates sound pressure in the case of 1.8λ, a one-dot chain line indicates sound pressure in the case of 0.5λ, and a two-dot chain line indicates sound pressure in the case of 0.25λ.

In FIGS. 3 to 5, when the acoustic matching layer 15 is not provided, theoretically, ultrasonic waves are output from the first surface 11A of the ultrasonic device 1 at an ideal sound pressure corresponding to a frequency. However, as described above, when the acoustic matching layer 15 is not provided, it is necessary to directly press the vibration plate 11 having high rigidity against the living body, the vibration plate 11 may be damaged, and air bubbles may occur.

On the other hand, when the acoustic matching layer 15 is formed, as shown in FIGS. 3 to 5, sound pressure changes depending on a frequency of ultrasonic waves.

That is, the acoustic matching layer 15 has wavelength dependence on the transmittance of ultrasonic waves, and the transmittance of the ultrasonic waves decreases, that is, the sound pressure of the ultrasonic waves transmitted to the living body decreases in a part of a frequency range. In particular, when ultrasonic diagnosis or ultrasonic treatment is performed from a shallow depth to a deep depth by transmitting ultrasonic waves from a surface of the living body, it may be necessary to widen a band of the ultrasonic waves. In this case, a significant change in sound pressure depending on a frequency is not preferable because such a change affects treatment efficiency and diagnostic accuracy.

In the embodiment, a thickness t of the acoustic matching layer 15 is set to satisfy at least t≤V/f based on a center frequency f of ultrasonic waves output from the first surface 11A and a sound velocity V of ultrasonic waves passing through the acoustic matching layer 15. When a wavelength of the ultrasonic waves is defined as λ, since V=fλ, the thickness t of the acoustic matching layer 15 satisfies t≤1.0λ.

For example, when the center frequency is set to 7 MHz in the ultrasonic device 1 in which the thickness of the acoustic matching layer 15 is t=1.8λ, as shown in FIG. 3, sound pressure transmitted through the acoustic matching layer 15 greatly fluctuates in the vicinity of 6 MHz, in the vicinity of 8 MHZ, and in the vicinity of 10 MHz as compared with a case where the acoustic matching layer 15 is not provided.

In contrast, when the center frequency is set to 7 MHz in the ultrasonic device 1 in which the thickness of the acoustic matching layer 15 is t=1.0λ, sound pressure transmitted through the acoustic matching layer 15 increases and decreases depending on a frequency, and a fluctuation of the sound pressure transmitted through the acoustic matching layer 15 is smaller than that in a case where the thickness of the acoustic matching layer 15 is t=1.8\ in a frequency range of 2 MHz to 10 MHz. Similarly, when the center frequency is set to 15 MHz, a fluctuation of the sound pressure transmitted through the acoustic matching layer 15 is smaller than that in a case where the thickness of the acoustic matching layer 15 is 1.8\ in a frequency range of 11 MHz to 20 MHz. The same applies to the ultrasonic device 1 in which the thickness of the acoustic matching layer 15 is set to t=0.5λ, and a fluctuation of sound pressure transmitted through the acoustic matching layer 15 is small in both a case where the center frequency is set to 7 MHz and a case where the center frequency is set to 15 MHz.

In the ultrasonic device 1 in which the thickness of the acoustic matching layer 15 is t=0.25λ, there is no significant fluctuation in sound pressure in a frequency range of 0.1 MHz to 20 MHz.

From the above, the acoustic matching layer 15 is preferably formed to satisfy t≤1.0\, and more preferably satisfies 0.5λ≤t≤1.0λ. This makes it possible to prevent a fluctuation in sound pressure caused by the acoustic matching layer 15 in a wide frequency range regardless of the center frequency.

V=λf, and V≥tf from a condition of t≤1.0\ in the embodiment. That is, a condition of t≤V/f is established. Accordingly, as the center frequency f of ultrasonic waves decreases, an allowable thickness t of the acoustic matching layer 15 can be increased.

For example, when the center frequency f is set to 0.5 MHz which is small, an influence of a sound pressure fluctuation can be sufficiently reduced regardless of the thickness t of the acoustic matching layer 15 as shown in FIG. 5.

Specifically, when a sound velocity V of ultrasonic waves is V=1000 m/s and the center frequency f is f=0.5 MHZ, t≤2.0 mm. On the other hand, when the center frequency f is f=15 MHz, 0.03 mm≤t≤0.07 mm.

That is, when an object is a living body (water), an influence of a sound pressure fluctuation can be prevented by setting the thickness t of the acoustic matching layer 15 to 0.03 mm≤t≤2.0 mm, and ultrasonic waves can be efficiently output to the object.

### Area of Vibration Plate Surrounded by Prevention Portions

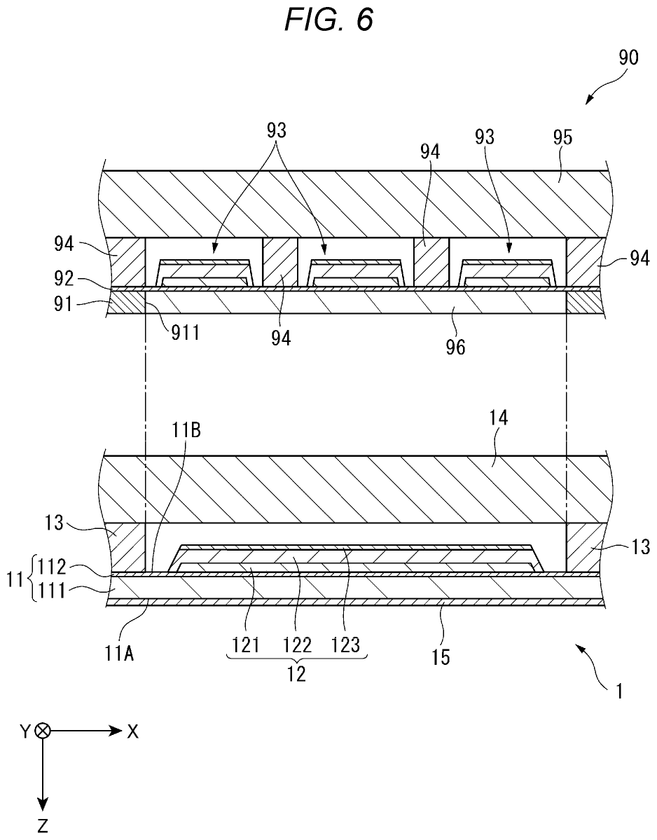

FIG. 6 is a diagram comparing schematic configuration of an ultrasonic device 90 in the related art serving as a comparative example with a schematic configuration of the ultrasonic device 1 according to the embodiment.

In the ultrasonic device 90 in the related art, as shown in FIG. 6, a plurality of openings 911 are formed in a support substrate 91, and a vibration plate 92 is provided to close the openings 911. When viewed in the Z direction, a plurality of piezoelectric elements 93 are provided on the vibration plate 92 at positions overlapping the openings 911, and prevention portions 94 are provided between the piezoelectric elements 93. Similar to the ultrasonic device 1 according to the embodiment, a sealing plate 95 is provided on an opposite side of the prevention portion 94 from the support substrate 91. The opening 911 is filled with an acoustic matching layer 96.

In the ultrasonic device 90 according to the comparative example, a vibration region of the vibration plate 92 surrounded by an edge of the opening 911 and an edge of the prevention portion 94 is determined, while in the embodiment, an area of a vibration region, more specifically, a distance between prevention portions in a short axis direction for determining a frequency is small.

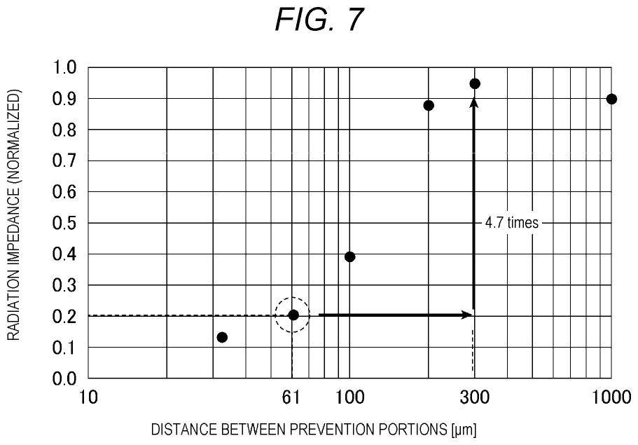

FIG. 7 is a diagram showing a relationship between a normalized radiation impedance and a distance between prevention portions. The radiation impedance is a value indicating a reaction force caused by vibration of the vibration plate relative to a displacement speed of the piezoelectric element, that is, a vibration speed of the vibration plate. A value obtained by dividing the radiation impedance by an area of a portion of the vibration plate 11 surrounded by the prevention portions 13 as viewed in the Z direction, a density of the vibration plate 11, and a sound velocity in an object is defined as a radiation impedance that is normalized (normalized radiation impedance).

In the ultrasonic device 90 according to the comparative example, a distance between prevention portions is smaller than 100 μm, and the normalized radiation impedance is less than 0.4. For example, when the distance between the prevention portions is 60 μm, the normalized radiation impedance is about 0.2.

However, in order to efficiently transmit ultrasonic waves from the ultrasonic devices 1 and 90 to an object (a living body), it is preferable to further increase the radiation impedance. In contrast, the normalized radiation impedance is formed to be 0.8 or more and 1.0 or less in the embodiment. Specifically, in the ultrasonic device 1 according to the embodiment, the distance between the prevention portions is 200 μm or more, and thus the normalized radiation impedance can be set to 0.8 or more and 1 or less. For example, when the distance between the prevention portions is 300 μm, the normalized radiation impedance is 0.95, and the normalized radiation impedance of 4.7 times the normalized radiation impedance in the comparative example is obtained.

### Effects of Embodiment

The ultrasonic device 1 according to the embodiment includes the vibration plate 11 having the first surface 11A and the second surface 11B that are flat surfaces, the acoustic matching layer 15 that is provided on the first surface 11A and is brought into contact with an object, the piezoelectric element 12 provided on the second surface 11B, and the prevention portion 13 that is formed in a frame shape as viewed from the Z direction, is disposed on the second surface 11B in a manner of surrounding the piezoelectric element 12, and prevents vibration of the vibration plate 11. When a thickness of the acoustic matching layer 15 is defined as t, a sound velocity of ultrasonic waves passing through the acoustic matching layer 15 is defined as V, and a center frequency of ultrasonic waves transmitted from the first surface 11A is defined as f, t≤V/f, that is, t≤1.0λ is satisfied.

In the ultrasonic device 1, even when the ultrasonic device 1 is pressed against a living body, damage to the vibration plate 11 can be prevented and generation of air bubbles can be prevented by providing the acoustic matching layer 15. As shown in FIGS. 3 to 5, the ultrasonic device 1 can prevent unevenness of the transmittance of ultrasonic waves for each frequency caused by the acoustic matching layer 15, and can prevent a sound pressure fluctuation in a wide frequency range. That is, ultrasonic waves can be efficiently transmitted to the object regardless of a frequency, and the wavelength unevenness can be prevented.

Further, the thickness of the acoustic matching layer 15 is preferably 0.5λ≤t≤1.0λ. Accordingly, even when the acoustic matching layer 15 is used in a wide frequency range, a sound pressure fluctuation can be prevented, and ultrasonic waves can be transmitted to an object with higher efficiency.

More specifically, when the object is a living body (water), the thickness t of the acoustic matching layer is preferably t≤2 mm. Accordingly, when the object is a living body (water), a sound pressure fluctuation can be further prevented.

In the ultrasonic device 1 according to the embodiment, the normalized radiation impedance obtained by dividing a radiation impedance by an area of a portion of the vibration plate 11 surrounded by the prevention portions 13 as viewed from the Z direction, a density of the vibration plate 11, and a sound velocity of ultrasonic waves is 0.8 or more and 1.0 or less.

This makes it possible to efficiently output ultrasonic waves from the ultrasonic device 1 to the object.

### Modification

The present disclosure is not limited to the embodiments and modifications described above. The present disclosure includes modifications, improvements, and configurations obtained by appropriately combining the embodiments within a scope where an object of the present disclosure can be achieved.

Although the object is described as a living body in the embodiment described above, the object is not limited thereto. For example, the object may be a concrete structure or air.

In this case, it is preferable to use a material having an acoustic impedance close to that of the object as the acoustic matching layer 15. Since a sound velocity of ultrasonic waves passing through the object is different depending on the object, the thickness t of the acoustic matching layer 15 capable of preventing a sound pressure fluctuation also changes depending on the object.

In the embodiment described above, as a specific example, when the object is a living body and the sound velocity V of ultrasonic waves is V=1000 m/s, the thickness t of the acoustic matching layer 15 is preferably 2.0 mm or less. As described above, when ultrasonic waves are transmitted to another object with a significantly different sound velocity, the thickness of the acoustic matching layer 15 is different depending on the object. On this case as well, the acoustic matching layer 15 may be formed with the thickness t satisfying V/2f≤t≤V/f. That is, the acoustic matching layer 15 may be formed satisfying t≥0.5V/f.

### SUMMARY OF DISCLOSURE

An ultrasonic device according to a first aspect of the disclosure includes a vibration plate having a first surface and a second surface opposite to the first surface, the first surface and the second surface being flat surfaces; an acoustic matching layer that is provided on the first surface and is brought into contact with an object; a piezoelectric element provided on the second surface; and a prevention portion that is formed in a frame shape as viewed from a normal direction of the second surface, is disposed on the second surface in a manner of surrounding the piezoelectric element, and prevents vibration of the vibration plate. When a thickness of the acoustic matching layer is defined as t, a sound velocity of ultrasonic waves is defined as V, and a center frequency of ultrasonic waves transmitted from the first surface is defined as f, t≤V/f is satisfied.

Accordingly, the acoustic matching layer 15 can prevent damage to the vibration plate and mixing of air bubbles. Even when a frequency changes, a sound pressure fluctuation can be prevented.

In the ultrasonic device according to the aspect, a thickness t of the acoustic matching layer preferably satisfies t≥0.5V/f.

Accordingly, similar to the above aspect, a sound pressure fluctuation can be further prevented, and ultrasonic waves can be transmitted to the object with high efficiency.

In the ultrasonic device according to the aspect, the thickness t of the acoustic matching layer is preferably 2 mm or less.

Accordingly, when the object is water or a living body containing water as a main component, a sound pressure fluctuation can be prevented, and transmission efficiency of ultrasonic waves to water or the living body can be improved.

In the ultrasonic device according to the aspect, it is preferable to set a normalized radiation impedance obtained by dividing, by an area of a portion of the vibration plate surrounded by the prevention portions as viewed from the normal direction of the second surface, a density of the vibration plate, and a sound velocity in the object, a radiation impedance indicating a force generated by vibration of the vibration plate relative to a vibration speed of the vibration plate that is caused to vibrate by the piezoelectric element, to 0.8 or more and 1 or less.

Accordingly, ultrasonic waves can be transmitted to the object with high efficiency.

What is claimed is:

1. An ultrasonic device comprising:
a vibration plate having a first surface and a second surface opposite to the first surface;
an acoustic matching layer that is provided on the first surface and is bought into contact with an object;
a piezoelectric element provided on the second surface; and
a prevention portion that is disposed in a manner of surrounding the piezoelectric element on the second surface, wherein
when a thickness of the acoustic matching layer is defined as t, a sound velocity of ultrasonic waves is defined as V, and a center frequency of ultrasonic waves transmitted from the first surface is defined as f, t≤V/f is satisfied.

2. The ultrasonic device according to claim 1, wherein
the thickness t of the acoustic matching layer satisfies t≥0.5V/f.

3. The ultrasonic device according to claim 1, wherein
the thickness t of the acoustic matching layer is 2 mm or less.

4. The ultrasonic device according to claim 1, wherein
a normalized radiation impedance is set to 0.8 or more and 1 or less, the normalized radiation impedance being obtained by dividing a radiation impedance by an area of a portion of the vibration plate surrounded by the prevention portions as viewed from the normal direction of the second surface, a density of the vibration plate, and a sound velocity in the object.
